(19) United States
(12) Patent Application Publication
(10) Pub. No.: US 2016/0085767 A1
(43) Pub. Date: Mar. 24, 2016

(54) TOPONYM RESOLUTION WITH ONE HUNDRED PERCENT RECALL

(71) Applicant: University of Maryland, College Park, College Park, MD (US)

(72) Inventors: Hanan SAMET, College Park, MD (US); Marco D. ADELFIO, Richmond, VA (US); Brendan C. FRUIN, Columbia, MD (US)

(21) Appl. No.: 14/862,780

(22) Filed: Sep. 23, 2015

Related U.S. Application Data
(60) Provisional application No. 62/054,173, filed on Sep. 23, 2014.

(51) Int. Cl. G06F 17/30; G06F 3/0484

(52) U.S. Cl. CPC G06F 17/30156; G06F 17/30241; G06F 17/30061; G06F 3/04842

(57) ABSTRACT

Various presentation systems may benefit from appropriate toponym resolution. For example, a system such as a search engine may benefit from toponym resolution with one hundred percent recall. A method can include receiving a set of geographic data comprising recognized toponyms. The method can also include recalling correctly all correctly recognized toponyms of the set. The recalling can include displaying the geographic data on a plurality of related displays. A first display can include at least a subset of the set. A second display can include an overview of the set.

### CROSS REFERENCE TO RELATED APPLICATIONS

This application is related to and claims the benefit and priority of U.S. Provisional Patent Application No. 62/054,173, filed Sep. 23, 2014, the entirety of which is hereby incorporated herein by reference.

### GOVERNMENT LICENSE RIGHTS

This invention was made with support under IIS 1219023 awarded by NSF. The government has certain rights in the invention.

### BACKGROUND

1. Field

Various presentation systems may benefit from appropriate toponym resolution. For example, a system such as a search engine may benefit from toponym resolution with one hundred percent recall.

2. Description of the Related Art

Toponym recognition can be just a matter of deciding whether or not a term corresponds to a toponym. Recognition can be evaluated in terms of both precision and recall. For toponym recognition, precision can be the ratio of the number of times the identification of a term as a toponym is correct and the number of such identifications as toponyms. This measure does not take into account the number of times a term which is a toponym has failed to be identified/classified as a toponym. Such accounting is the role of the recall measure, which can be the ratio of the number of terms that have correctly been identified as toponyms and the number of terms that have been processed that are indeed toponyms.

Determining which terms are indeed toponyms can be done by manually annotating the documents containing the toponyms, which may be a tedious process especially if there are many documents.

High precision means a low number of false positives, and high recall means a low number of false negatives. Intuitively, the false positives are the terms that are wrongly classified as toponyms, and the false negatives are the toponyms that were not classified as toponyms and hence missed. Systems may be designed to keep both the number of false positives and the number of false negatives low.

Toponym resolution is much more complex than toponym recognition, as it is a matter of determining the correct interpretation of a term that has been identified as a toponym.

Thus the two processes are related in the sense that they can be executed in sequence. Again, toponym resolution can be evaluated in terms of both precision and recall. For toponym resolution, precision can be the ratio of the number of times the identification of a term as a toponym by the toponym recognition process has been correctly resolved and the number of times that a term has been identified as a toponym by the toponym recognition process. The measure does not take into account the number of times that a term which is a toponym has failed to be identified/classified as a toponym by the toponym recognition process.

Again, this may be the role of the recall measure which is the ratio of the number of toponyms that have been correctly resolved and the number of terms that have been processed that are indeed toponyms, regardless of whether or not the toponym recognition process has classified them as toponyms This means that if a toponym has not been recognized, then it is deemed as not being resolved correctly even though the toponym resolution process could have possibly resolved it were it given an opportunity to do so. Thus, the toponym resolution recall rate may be lower than it otherwise could possibly be.

### SUMMARY

According to certain embodiments, a method can include receiving a set of geographic data comprising recognized toponyms. The method can also include recalling correctly all correctly recognized toponyms of the set. The recalling can include displaying the geographic data on a plurality of related displays. A first display can include at least a subset of the set. A second display can include an overview of the set.

In certain embodiments, an apparatus can include at least one processor and at least one memory including computer program code. The at least one memory and the computer program code can be configured to, with the at least one processor, cause the apparatus at least to receive a set of geographic data comprising recognized toponyms. The at least one memory and the computer program code can also be configured to, with the at least one processor, cause the apparatus at least to recall correctly all correctly recognized toponyms of the set. Recalling can include displaying the geographic data on a plurality of related displays. A first display can include at least a subset of the set. A second display can include an overview of the set.

According to certain embodiments, an apparatus can include means for receiving a set of geographic data comprising recognized toponyms. The apparatus can also include means for recalling correctly all correctly recognized toponyms of the set. The recalling can include displaying the geographic data on a plurality of related displays. A first display can include at least a subset of the set. A second display can include an overview of the set.

A non-transitory computer-readable medium can, in certain embodiments, be encoded with instructions that, when executed in hardware, perform a process. The process can be the above-described method.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

### DETAILED DESCRIPTION:

An object of certain embodiments of the present invention is to change and offer an alternative to the news reading process and, most importantly, experience. Users can query a system according to certain embodiments by choosing a region of interest and finding relevant associated topics/articles. The topics/articles that are displayed can be determined by the location and level of zoom which together dictate the spatial scope, which can be described as the region of interest. There are at least two ways of interpreting the notion of “region of interest.” One interpretation is in terms of content, while a second interpretation can be in terms of the news sources.

In certain embodiments, there may be no predetermined boundaries on the locations of the news sources for the articles that are displayed for the region of interest. In other embodiments, the sources can be limited to a subset of the available sources, such as particular newspapers, by language, or by spatial region. Spatial region can be specified textually, for example restrict the sources to lie in Ireland, or by drawing the region of interest on the map, such as a box overlapping both Ireland and the United Kingdom.

Both the spatial region and the news sources can be constrained and the constraints do not need to be the same. For example, non-overlapping constraints can allow users to see how one part of the world views events in another part of the world. For example, one may wish to analyze how the English press views/interprets developments in the Middle East, or how the Middle East press views/interprets developments in England. The result may be analogous to sentiment analysis. Other applications can include monitoring hot spots, which may be useful for investors, national security, and keeping up with spread of diseases.

In certain embodiments, a system can output a map in response to a query such as “What is happening at location X on Mar. 26, 2014? This mode of the system can be termed “Map Mode.” X can be Africa, Europe, and part of the Americas. A text box on the map can show an excerpt from an article about the Obama/Putin relationship that mentions Moscow, since that was something identified as relevant to that date and location. Other modes are also possible, include a “Top Stories Mode.” In this mode, the system can provide an output, including a map, in response to a query such as “Where is event Y happening on Mar. 26, 2014.”

Each icon or symbol on the map, which can be generally referred to as a marker on the map, can represent a set of articles on the same and/or different topics where the main property that is shared by all of the articles is that they are associated with the corresponding map location. The association can be that they all in some way mention the map location.

The type of the symbol used as the marker can convey information about the news category into which the majority of the article topics associated with the location fall, such as general news, business, science and technology, entertainment, health, sports, or the like. These symbol types can be controlled by an interface, such as by toggling appropriate buttons at suitable location on the screen, such as at the top of the screen.

An information bubble can be presented when a mouse cursor passes over one of the markers. For example, an information bubble containing the headline from a representative article on a dominant topic, in this case the Obama/Putin relationship, may be associated with Moscow. These topics can be obtained by applying a clustering process to all of the articles. The information bubble can be generated by the act of the mouse cursor hovering over Moscow.

The hovering action can also cause the markers at all other locations on the map that are associated with this representative article to be replaced by some different marker, such as orange balls. In this example, these locations correspond, in part, to the countries involved in, or affected by, the Obama/Putin relationship. Some of these locations may lie outside the geographic span of the map that is currently visible on the screen. For example, the screen may narrowly illustrate Europe, but the locations may be in North America and the Far East.

The limitation of the current map view on screen can be overcome by a minimap, which can be generated when hovering over a marker along with the headline. The minimap can display the geographic span of the representative article with, for example, orange balls at the appropriate locations. The minimap may permit users ease viewing of a selected article's geographic focus, without having to leave the user's area of interest on the main map. The minimap can also be independent of a current level of zoom. In certain instances, a current zoom within a user's area of interest may not show all of the relevant locations. Thus, in such cases the minimap may assist in also showing areas within the user's area of interest but outside a current zoom, since the zoom may preclude such areas from being highlighted on the part of the map that is visible.

Other markers, such as blue balls on both the main map and the minimap, can be used to indicate other locations with the same name as the one over which the user's cursor is currently hovering, for example Moscow). This may cause the geographic span of the minimap to exceed that of the orange balls. The blue balls can enable detecting toponym resolution errors.

Another marker, such as black ball on the minimap, can mark the location over which the user is currently hovering. In this example, the user may be hovering over Moscow. Up and down arrows on the minimap can enable scrolling through the orange and blue balls and outputting the corresponding location names. Scrolling through the blue balls can enable ranking the interpretations of the location name.

Green and red balls on the minimap can correspond to the current blue and orange balls in the scrolling process. In other words, the blue or orange balls can change to green and red balls, respectively, as they are currently selected in the minimap.

In certain embodiments, hovering in the minimap over an orange ball can yield the name of the location while hovering over a blue ball can yield both the name of the location and its containing location on the minimap, such as Moscow, Idaho, United States, as all blue balls may have the same or similar name.

Thus, in certain embodiments more generally, a hovering action over name n of a location can also cause the generation of blue balls at all other locations k with the same name n on both the map and minimap, such that at least one article cluster is associated with k. This can enables the system or its users to quickly detect toponym resolution errors by providing access to all articles determined to mention a particular location name n for any interpretation k of n. This may be the case as long as at least one article is associated with interpretation k even though k may not be the correct interpretation of the occurrence of n for the article cluster in question, thereby letting the user make the final decision.

Effectively, the user can examine all mentions of n for the correct interpretation of k subject to the stipulation that at least one article is associated with each interpretation. Assuming 100% recall for toponym recognition with lower precision, as there could be many terms that were wrongly classified as toponyms, the system can provide 100% recall for toponym resolution for the interpretations of a location that is in a gazetteer.

The precision of toponym resolution may be lower due to taking all of the interpretations into account in forming the denominator of the precision, but at least the system can avoid missing any. In some sense our article clusters can be ranked, where the highest ranked one can be associated with the queried location on the main map and the lower ranked ones can be associated with the locations corresponding to the blue balls on the minimap.

In certain embodiments, an information bubble can show headlines of representative articles for each of the topics associated with a currently selected location, such as Moscow in the example above. This selected location may be the location over which the mouse is currently or was recently hovering. The list of headlines may result from a user clicking to obtain the information, such as clicking on a greater-than symbol, “>”. Clicking on one of the headlines can yield a summary info bubble as well as an adjacent corresponding minimap which can be generated when hovering over a marker, as described earlier. The summary info bubble can also contain links to related images, videos, and other articles. Clicking on the headline in this summary info bubble can cause the full text of the article to be displayed. If the article is in a language other than English, then an option can be provided to translate the article and/or the headline into English using a translation package such as Google Translate and Microsoft Translator. In this example, English is the default language, although the translated-into language could be any desired language.

The domain of news sources for the articles from which the representative article is drawn can be restricted by language, geographic region or country, as well as specific newspapers, by setting up an appropriate filter. This filter may be set up through a configuration or settings menu, which can be accessed using, for example, an appropriately labelled button

In certain embodiments, users may also be able to do a search by location or keyword(s) as well as vary the number of markers to be displayed by using a display slider. An example interface is accessible at http://newsstand.umiacs.umd.edu, which is based on the inventors' own work.

The minimap feature can also be activated via other modes. For example, in a top stories mode, headlines or topics can be given in a pane of a display. These headlines can be ranked using an importance measure, where importance can be defined in terms of factors such as significance, age, and frequency, although velocity/acceleration of arrival in the cluster can also be taken into account.

A particular headline can be displayed based on being clicked by the user. This headline can be highlighted, for example by being grayed, as a result of hovering over it, and in this example can correspond to the Obama/Putin relationship topic. Clicking on the headline can cause more details to appear about it in a second pane, such as an expanded description, the number of related documents, images, and videos, as well as a means to access them via a subsequent mouse click.

The hovering click in the first pane can also cause appropriate markers or category symbols to appear on a map in a third pane at the principal geographic locations associated with the topic. In this example, these locations can correspond, in part, to some of the countries involved in, or affected by, the Obama/Putin relationship, which include the US and Russia. Hovering the mouse cursor on the map in the third pane can cause info bubbles to appear as in the previously described map mode. Similarly, again, the associated minimap can also be provided with the same semantics, either superimposed on the third pane or in a fourth pane.

As mentioned above, the markers for different categories of further information can be differentiated. For example, a set of orange balls can enable differentiating between locations that are in close proximity such as London and Wimbledon in the UK for a tennis cluster, while blue balls can capture other instances of geographic locations with the same name, such as Moscow, Pennsylvania, United States.

In either map or top stories modes users may be able to obtain the collection of images and videos associated with each cluster.

For images, certain embodiments may be able to detect duplicates or near duplicates and hide them from view. Certain embodiments, more particularly, may use the words associated with the articles, for example the semantics of the words, as the primary step in finding similar images. Duplicates among these similar images can be detected using classical image similarity methods including hierarchical color histograms and SIFT. Other image duplication detection mechanisms can also be employed. Using the text-based approach to limit the field of search for duplicate images may simplify the computation necessary in de-duplification.

Thus, certain embodiments may make a map a medium for the presentation of information that has spatial relevance. Thus, certain embodiments are not restricted to news articles. For example, certain embodiments can also be applied to search results, images, videos, tweets, and so on. In addition, certain embodiments may enable both a summarization of the news as well as further exploration and even knowledge acquisition via discovery of patterns in the news.

Discovery of such patterns in the news may be a direct result of the association of topics or categories with the locations that are mentioned in their constituent articles. For example, queries can be chained in the sense that an interesting topic might be found in Paris, France, and the same topic might also be associated with London, UK, which may be found via the orange balls.

For example, the mouse or other pointing device can be directed to London on the map. The pointing device can then be clicked to find other related topics that mention London, as well as other locations to which the user can transition by simply moving via the map query interface.

This unlimited chaining may be only possible in map mode, because the queries are location-based while the queries in top stories mode may be topic-based. In the latter mode, the markers that appear on the map may be restricted to the locations that correspond to the highest ranked topics, unless the user does a keyword search.

As another example, a cluster disease focus can be a selected option for presentation. In this case, given a cluster of articles, such as Europe on Mar. 26, 2014, the most common term in the cluster that corresponds to the name of a disease can be identified. Alternatively, the system can apply the same idea and find the most common term in the cluster that corresponds to the name of a person or mention of a brand. These can be achieved by setting a “layers” parameter to “disease,” “people,” or “brand,” respectively.

Certain embodiments may be able to achieve 100% recall for toponym resolution. This may assume that all toponyms have been recognized. In other words, assuming 100% toponym recognition recall, certain embodiments may achieve 100% recall for toponym resolution. For example, a minimap can show all interpretations for a textual specification of a location which are associated with at least one document. This means that a user can have access to all documents that mention a specific location as long as the textual specification to the location has been recognized as a location rather than as the name of another entity such as a person, company, organization, or the like.

In other words, in certain embodiments ambiguous toponyms can still be resolved at an 100% recall rate, assuming that there has been an 100% rate for toponym recognition recall. News articles, for example, can be retrieved based on determining the actual locations that are mentioned in them. The articles can then be presented for access using a map query interface.

News articles can be obtained in a variety of way. For example, the system can crawl the world wide web looking for really simple syndication (RSS) news feeds and collect the articles that the news feeds transmit. The system can determine the geographic locations mentioned in each article by applying an appropriate geotagging process. The system can also try to determine the geographic focus or foci of the articles, such as the key location(s) mentioned in the article. In addition, the system can aggregate news articles by topic based on content similarity, for example using a clustering method, so that articles about the same news event can be grouped into the same cluster, also, at times, referred to equivalently as a topic.

In another example, the user may hover a cursor over Moscow, Pennsylvania. In that case, there may be an info bubble with headlines from a number of clusters associated with that location. The text of the constituent articles may only contain the term Moscow with no qualifying information, yet the toponym resolution process may have correctly identified them as being associated with Moscow, Pennsylvania.

Nevertheless, the minimap can act as a very compact summary of all possible interpretations for a particular toponym. Thus users can have access to all possible data that is associated with an ambiguously specified toponym.

Moreover, if the toponym resolution process makes an error in choosing the correct interpretation, then the user can still find it by going through all of the interpretations that are presented with the blue balls. The order in which the user processes the various interpretations may not be the most optimal, as the user may have to process a number of irrelevant interpretations. In other words, the toponym resolution process may not have ranked the interpretations in an optimal manner for this particular toponym.

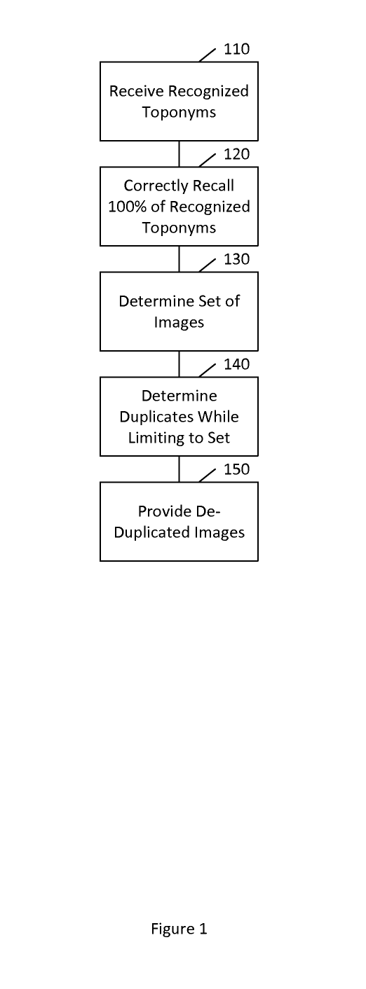

FIG. 1 illustrates a method according to certain embodiments. As shown in FIG. 1, a method can include, at 110, receiving a set of geographic data comprising recognized toponyms. This set of data can be received from another module, unillustrated, that performs toponym recognition. Certain embodiments may not address a situation in which toponym recognition is performed incorrectly, but certain embodiments may maximize the performance for all correctly recognized toponyms in a set.

More particularly, at 120, the method can include recalling correctly all correctly recognized toponyms of the set. The recalling can include displaying the geographic data on a plurality of related displays. A first display can include at least a subset of the set and a second display can include an overview of the set.

The first display can be a map and the second display can be a minimap. There may be other ways to display the first and second displays. For example, a holographic projection could be used instead of a more traditional map, or any other way of depicting cartographic information may be used.

The second display can be generated responsive to a cursor hovering over a marker of the first display. The marker for the first display may be any desired icon, image, or symbol. A few examples are discussed above. For example, the symbol may be a colored ball. Other triggers for the second display, besides hovering, are also permitted.

The set of data can include documents. For example, the documents can be newspaper articles, journal articles, social media entries, transcripts of oral media reports, or the like. Any text source can potentially be included the data set. Non-text sets can be converted to text by techniques such as voice recognition. Relevant text can then be extracted from the corresponding report.

The second display can include a first set of markers corresponding to locations associated with a currently selected element of the set. These may be, for example, the orange balls discussed above, or any other symbol. The currently selected element of the set may be a particular article. More particularly, the currently selected element can be the association of that particular article with a particular location. Hovering over a selected one of the first set of markers can generate an identification of the location of the selected one of the first set of markers. This may help in identifying the location beyond simply the placement on a map.

The second display can also include a second set of markers corresponding to locations having a same name as a primary location associated with a currently selected element of the set. In certain embodiments only the second set of markers may be displayed. For example, there may be a user configuration setting that permits only the first set, only the second set, or both sets to be displayed. Hovering over a selected one of the second set of markers can generate a distinguishing identification of the location of the selected one of the second set of markers. For example, since the names of the all the second set items may be the same, the distinguishing identification can provide some further information based on the common name, so that the various marks can be readily identified.

A number of markers corresponding to the set in the second display can be controlled using a display slider. Furthermore, the number of markers can be controlled by other techniques, such as a zoom feature.

The method can further include, at 130, determining a first set of images associated with geographically related articles corresponding to the set. For example, a user can select an image associated with the article, and the system may identify other geographically related articles containing or other geographically related images.

The method can also include, at 140, detecting duplicate or near duplicate images within the first set of images while limiting duplication consideration to images within the first set. As mentioned above, such detection may rely on any conventional duplication detection approach, but the set of candidate images can be limited to those identified at 130. The method can further include, at 150, providing a de-duplicated set of images to the user. This set can be provided as a collage of images or in any other desired format.

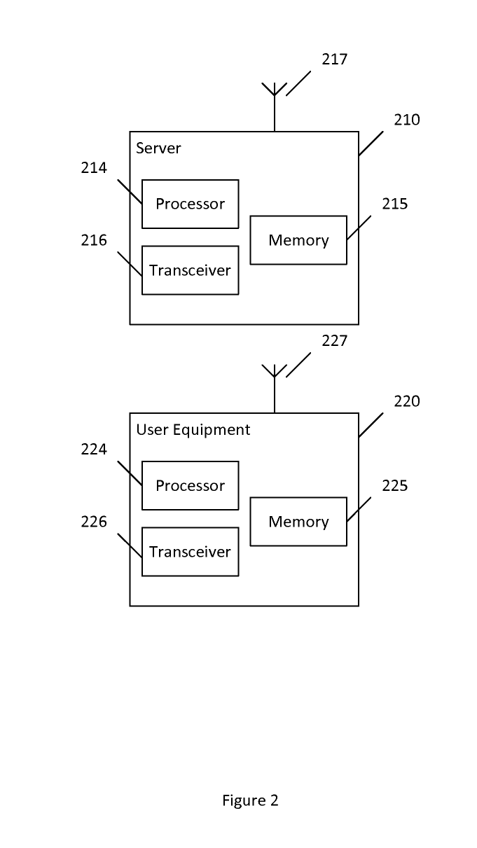

FIG. 2 illustrates a system according to certain embodiments of the invention. It should be understood that each block of the flowchart of FIG. 1 may be implemented by various means or their combinations, such as hardware, software, firmware, one or more processors and/or circuitry. In one embodiment, a system may include several devices, such as, for example, server 210 and user equipment (UE) or user device 220. The system may include more than one UE 220 and more than one server 210, although only one of each is shown for the purposes of illustration. A server can be any computing device remote from the UE 220.

Each of these devices may include at least one processor or control unit or module, respectively indicated as 214 and 224. At least one memory may be provided in each device, and indicated as 215 and 225, respectively. The memory may include computer program instructions or computer code contained therein, for example for carrying out the embodiments described above. One or more transceiver 216 and 226 may be provided, and each device may also include an antenna, respectively illustrated as 217 and 227. Although only one antenna each is shown, server 210 and UE 220 may be additionally configured for wired communication, in addition to or instead of wireless communication, and in such a case antennas 217 and 227 may illustrate any form of communication hardware, without being limited to merely an antenna.

Transceivers 216 and 226 may each, independently, be a transmitter, a receiver, or both a transmitter and a receiver, or a unit or device that may be configured both for transmission and reception.

A user device or user equipment 220 may be any terminal device, such as a computer, personal data or digital assistant (PDA), or the like. In an exemplifying embodiment, an apparatus, such as a node or user device, may include means for carrying out embodiments described above in relation to FIG. 1.

Processors 214 and 224 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof

For firmware or software, the implementation may include modules or unit of at least one chip set (e.g., procedures, functions, and so on). Memories 215 and 225 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as server 210 and/or UE 220, to perform any of the processes described above (see, for example, FIG. 1). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 2 illustrates a system including a server 210 and a UE 220, embodiments of the invention may be applicable to other configurations, and configurations involving additional elements, as illustrated and discussed herein. For example, multiple user equipment devices and multiple servers may be present.

Certain embodiments may have various benefits and/or advantages. For example, assuming 100% recall for toponym recognition, certain embodiments may provide 100% recall for toponym resolution by, for example, the addition of a minimap that shows all interpretations for a textual specification of a location which are associated with at least one document. This means that a user may have access to all documents that mention a specific location as long as the textual specification to the location has been recognized as a location rather than as the name of another entity such as a person, company, organization, or the like.

The map and/or minimap can be a very concise representation of the choices. By contrast, a conventional query to a text search engine may not be able to provide an overview of the possible responses other than to allow the reader to page through them screen by screen.

In the case of the minimap, users may also eventually make use of a zoom operation to get more interpretations if such a high volume exists. However, even though there may be many interpretations for a location, it may be rare for more than just a few interpretations to be possible for typical documents. This may especially be the case for particular news sources that do not span all locations on the globe.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
receiving a set of geographic data comprising recognized toponyms; and
recalling correctly all correctly recognized toponyms of the set, wherein the recalling comprises displaying the geographic data on a plurality of related displays,
wherein a first display comprises at least a subset of the set, and
wherein a second display comprises an overview of the set.

2. The method of claim 1, wherein the first display comprises a map and the second display comprises a minimap.

3. The method of claim 1, wherein the second display is generated responsive to a cursor hovering over a marker of the first display.

4. The method of claim 1, wherein the set of data comprise documents.

5. The method of claim 4, wherein the documents comprise at least one of newspaper articles, journal articles, social media entries, or transcripts of oral media reports.

6. The method of claim 1, wherein the second display comprises a first set of markers corresponding to locations associated with a currently selected element of the set.

7. The method of claim 6, wherein hovering over a selected one of the first set of markers generates an identification of the location of the selected one of the first set of markers.

8. The method of claim 1, wherein the second display comprises a second set of markers corresponding to locations having a same name as a primary location associated with a currently selected element of the set.

9. The method of claim 8, wherein hovering over a selected one of the second set of markers generates a distinguishing identification of the location of the selected one of the second set of markers.

10. The method of claim 1, wherein a number of markers corresponding to the set in the second display is controlled using a display slider.

11. The method of claim 1, further comprising:
determining a first set of images associated with geographically related articles corresponding to the set;
detecting duplicate or near duplicate images within the first set of images while limiting duplication consideration to images within the first set; and
providing a de-duplicated set of images to the user.

12. An apparatus, comprising:
at least one processor; and
at least one memory including computer program code,
wherein the at least one memory and the computer program code are configured to, with the at least one processor, cause the apparatus at least to
receive a set of geographic data comprising recognized toponyms; and
recall correctly all correctly recognized toponyms of the set, wherein the recalling comprises displaying the geographic data on a plurality of related displays,
wherein a first display comprises at least a subset of the set, and
wherein a second display comprises an overview of the set.

13. The apparatus of claim 12, wherein the first display comprises a map and the second display comprises a minimap.

14. The apparatus of claim 12, wherein the second display is generated responsive to a cursor hovering over a marker of the first display.

15. The apparatus of claim 12, wherein the set of data comprise documents.

16. The apparatus of claim 15, wherein the documents comprise at least one of newspaper articles, journal articles, social media entries, or transcripts of oral media reports.

17. The apparatus of claim 12, wherein the second display comprises a first set of markers corresponding to locations associated with a currently selected element of the set.

18. The apparatus of claim 17, wherein hovering over a selected one of the first set of markers generates an identification of the location of the selected one of the first set of markers.

19. The apparatus of claim 12, wherein the second display comprises a second set of markers corresponding to locations having a same name as a primary location associated with a currently selected element of the set.

20. The apparatus of claim 19, wherein hovering over a selected one of the second set of markers generates a distinguishing identification of the location of the selected one of the second set of markers.

21. The apparatus of claim 12, wherein a number of markers corresponding to the set in the second display is controlled using a display slider.

22. The apparatus of claim 12, wherein the at least one memory and the computer program code are configured to, with the at least one processor, cause the apparatus at least to:
determine a first set of images associated with geographically related articles corresponding to the set;
detect duplicate or near duplicate images within the first set of images while limiting duplication consideration to images within the first set; and
providing a de-duplicated set of images to the user.
